(19) United States
(12) Patent Application Publication
(10) Pub. No.: US 2010/0306363 A1
(43) Pub. Date: Dec. 2, 2010

(54) DETERMINING COMPLETION OF A WEB SERVER DOWNLOAD SESSION AT A DATABASE SERVER

(76) Inventors: Erwien Saputra, Bothell, WA (US); Vijaykumar Ramanujam, Kirkland, WA (US); Nabeel Abuhamdeh, Bellevue, WA (US); Prashanth Nimmagadda, Bothell, WA (US); Jared Parker, Bothel, WA (US); Viet Pham, Renton, WA (US); Talpa Saibaba Talluri Venkata Sesha, Bellevue, WA (US); Syed Khuda Bakash Sohail, Issaquah, WA (US); Mike Moore, Snohomish, WA (US); Kelly Sheffield, Redmond, WA (US)

Correspondence Address: MICROSOFT CORPORATION, ONE MICROSOFT WAY, REDMOND, WA, 98052, US

(21) Appl. No.: 12/471,733

(22) Filed: May 26, 2009

(51) Int. Cl. G06F 15/173; G06F 17/30; G06F 15/16

(52) U.S. Cl. 709/224; 709/203; 707/E17.032

(57) ABSTRACT

Techniques are described herein for determining completion of a Web server download session at a database server. A Web server initiates a download session for downloading a requested resource (e.g., a file or an output of an executable) to a client. The download session includes download operation(s), each corresponding to a respective portion of the requested resource. The Web server incorporates a session-specific identifier indicative of the download session and/or byte range indicator(s) corresponding to the respective download operation(s) into Web server log files. The database server uses the session-specific identifier and/or byte range indicator(s) to determine that the download operation(s) are included in the download session. The database server determines a download pattern corresponding to the download session based on download request(s) that correspond to the download operation(s). The database server determines whether the download session is complete using an algorithm that is indicative of the download pattern.

### BACKGROUND

Web servers commonly provide resources to clients in response to receiving requests from the clients. For instance, a client may request a resource using a browser by clicking a “download” button that is presented on a displayed Web site, thereby generating a hypertext transfer protocol (HTTP) request that is presented to the Web server that hosts the Web site. When a client requests a resource from a Web server, the Web server downloads the requested resource to the client. In some cases, the Web server may download the entire requested resource to the client using a single download. However, some resource downloads that occur in the real-world are more complex.

For instance, a client may cancel a download before the entire requested resource is downloaded. In another situation, a client may pause and resume a download session, resulting in multiple downloads being performed for downloading respective portions of the requested resource. In yet another situation, the client may initiate multiple downloads for downloading respective portions of the requested resource simultaneously. In still another situation, it may be desirable or necessary for a Web server to use multiple partial downloads, each corresponding to a respective portion of a requested resource, for downloading a requested resource.

In some situations, it may be desirable to track the number of complete resource downloads performed by a web server. Conventional download tracking techniques that are available to system administrators often interpret each download as a complete resource download (i.e., a download of an entire requested resource), even though such downloads often correspond to respective portions of a requested resource. Because partial downloads may be misinterpreted as complete resource downloads, a tracked number of complete resource downloads may be inaccurate. In fact, the tracked number of complete resource downloads may exceed the number of resource downloads actually performed.

### SUMMARY

Various approaches are described herein for, among other things, determining a completion of a Web server download session (i.e., a download of an entire requested resource) at a database server. Web servers store (or otherwise have access to) resources that the Web servers may download to a client in response to requests that are received from a user. For instance, a user may click a download button to cause a Web server to download a resource. Approaches are described herein to determining the completion of these and other types of resource downloads.

When a client requests a resource from a Web server, the Web server initiates a Web server download session for downloading the requested resource to the client. The download session includes one or more download operations, each of which corresponds to a respective portion of the requested resource. For instance, the user may provide a plurality of download requests, each corresponding to a respective download operation. The Web server is capable of modifying Web server log entries corresponding to respective download requests to include a session-specific identifier and/or respective byte range indicators to facilitate determining completion of a download session. The session-specific identifier is indicative of the download session, which is used to download the resource. The byte range indicators specify respective portions of the resource, which are downloaded in respective download operations of the download session.

The database server uses the session-specific identifier and/or the byte range indicators received from the Web server to determine whether the download session is complete. For instance, the database server uses the session-specific identifier to determine which download operation(s) are included in the download session. The database server determines a download pattern corresponding to the download session based on download request(s) that correspond to the download operation(s). The database server determines whether the download session is complete using an algorithm that is indicative of the download pattern. For example, a different algorithm may be used for each download pattern.

In an example implementation, a method for determining a download completion is provided. A session-specific identifier is received at a database server from a Web server. The session-specific identifier is indicative of a download session regarding a resource that is provided by the Web server. A determination is made at the database server (e.g., using one or more processors of the database server) that one or more download operations are included in the download session. The determination is based on an association between the session-specific identifier and each of the download operations that are included in the download session. A download pattern corresponding to the download session is determined based on one or more download requests, which correspond to the download operations. A determination is made as to whether the download session is complete using an algorithm that is indicative of the download pattern.

In another implementation, a database server is disclosed that includes a database, an association determination module, a pattern determination module, and a completion determination module. The database is coupled to a Web server for receiving a session-specific identifier from the Web server. The session-specific identifier is indicative of a download session regarding the resource, which is provided by the Web server. The association determination module is configured to determine that one or more download operations are included in the download session. The association determination module makes the determination based on an association between the session-specific identifier and each of the download operations that are included in the download session. The pattern determination module is configured to determine a download pattern corresponding to the download session. The pattern determination module determines the download pattern based on one or more download requests that correspond to the download operation(s) that are included in the download session. The completion determination module is configured to determine whether the download session is complete using an algorithm that is indicative of the download pattern.

A computer program product is also described. The computer program product includes a computer-readable medium having computer program logic recorded thereon for enabling a processor-based system to determine completion of a download session regarding a resource that is provided by a Web server. The computer program product includes first, second, and third program logic modules. The first program logic module is for enabling the processor-based system to determine that one or more download operations are included in the download session. The determination is based on an association between a session-specific identifier received from the Web server and each of the download operation(s). The session-specific identifier is indicative of the download session. The second program logic module is for enabling the processor-based system to determine a download pattern corresponding to the download session. The determination is based on one or more download requests that correspond to the download operation(s). The determination is further based on one or more byte range indicators that specify one or more respective portions of the resource that are associated with the download request(s). The third program logic module is for enabling the processor-based system to determine whether the download session is complete using an algorithm that is indicative of the download pattern.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example computer network in accordance with an embodiment.

FIG. 2 depicts a flowchart of a method for providing information to facilitate determining completion of a Web server download session in accordance with an embodiment.

FIG. 3 is a block diagram of an example implementation of a Web server shown in FIG. 1 in accordance with an embodiment.

FIGS. 4, 6, 8, and 10 depict flowcharts of methods for determining completion of a Web server download session in accordance with embodiments.

FIG. 5 is a block diagram of an example implementation of a database server shown in FIG. 1 in accordance with an embodiment.

FIGS. 7, 9, and 11 are block diagrams of example implementations of a completion determination module shown in FIG. 5 in accordance with embodiments.

FIG. 12 depicts an example computer that may be used to implement various aspects of the embodiments.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments for Determining Completion of a Web Server Download Session

When a client requests a resource from a Web server, example embodiments initiate a Web server download session for downloading the requested resource to the client. The download session includes one or more download operations, each of which corresponds to a respective portion of the requested resource. Examples of resources include but are not limited to files and output of executables residing on the Web server. Resource files may be of any suitable type, such as Adobe® PDF documents, Microsoft® Office documents, WordPerfect® documents, images, etc.

Although a simple download session may include a single download operation that is performed by a single Web server in response to a single download request, a download session may be more complex. For instance, a download session may include a plurality of download operations corresponding to a plurality of respective download requests. The download operations may be performed among any number of Web servers. For example, a client may pause and resume a download session, resulting in multiple download operations being performed for downloading respective portions of the requested resource. In another example, the client may initiate multiple download operations for downloading respective portions of the requested resource simultaneously. Additionally or alternatively, a client may cancel a download session before the entire requested resource is downloaded, or a client may get disconnected from a Web server.

According to some example embodiments, a Web server is capable of modifying Web server log entries to include a session-specific identifier and/or byte range indicator(s) to facilitate determining completion of a Web server download session. The session-specific identifier is indicative of the download session, which is used to download a resource. The byte range indicator(s) specify respective portion(s) of the resource, which are downloaded in respective download operation(s) of the download session.

In accordance with some example embodiments, a database server uses a session-specific identifier provided by a Web server to determine download operation(s) that are included in a Web server download session. For instance, the Web server may associate the session-specific identifier with each download operation that is included in the download session before the Web server provides the session-specific identifier to the database server. The database server determines a download pattern corresponding to the download session based on download request(s) that correspond to the download operation(s) that are included in the download session. The database server determines whether the download session is complete (i.e., whether an entire requested resource is downloaded with respect to the download session) using an algorithm that is indicative of the download pattern. For instance, a different algorithm may be used for each download pattern.

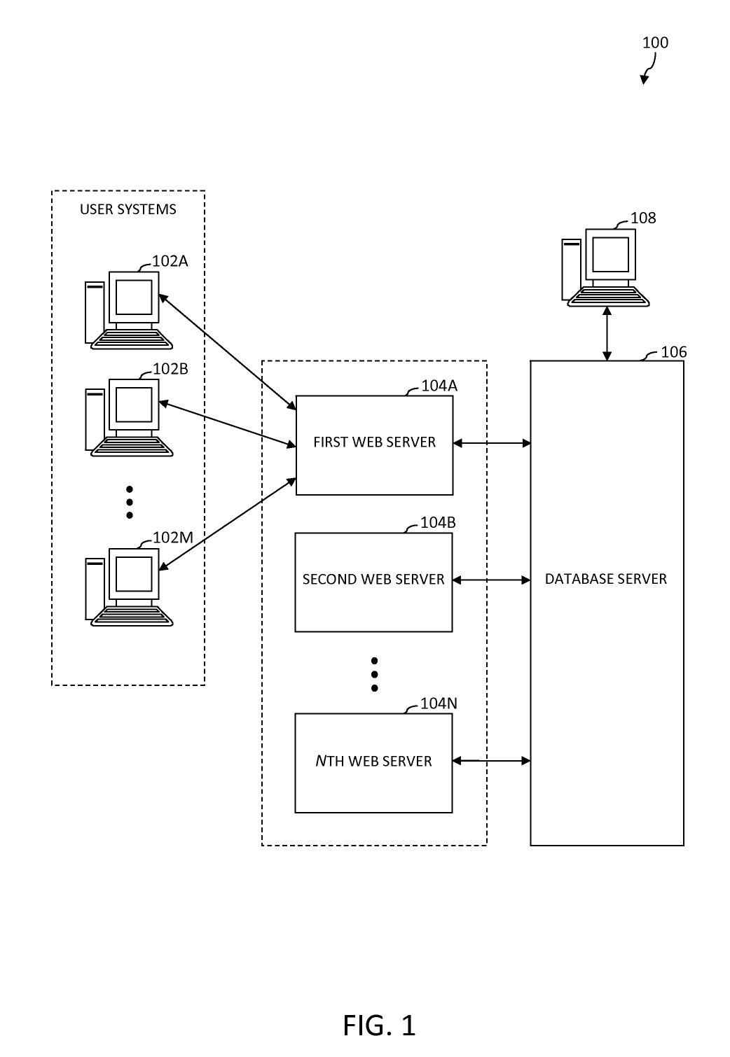

FIG. 1 is a block diagram of an example computer network 100 in accordance with an embodiment. Generally speaking, computer network 100 operates to provide resources to users of network 100 in response to HTTP requests provided by the users. Computer network 100 includes a plurality of user systems 102A-102M, a plurality of Web servers 104A-104N, a database server 106, and an administration (admin) system 108. Communication among user systems 102A-102M, Web servers 104A-104N, database server 106, and administration (admin) system 108 is carried out over a wide area network, such as the Internet, using well-known network communication protocols. Additionally or alternatively, the communication may be carried out over a local area network (LAN) or another type of network.

User systems 102A-102M are computers or other processing systems, each including one or more processors, that are capable of communicating with Web servers 104A-104N. User systems 102A-102M are capable of accessing Web sites hosted by Web servers 104A-104N, so that user systems 102A-102M may request resources that are available via the websites. User systems 102A-102M are configured to provide HTTP requests to Web servers 104A-104N for requesting resources stored on (or otherwise accessible via) Web servers 104A-104N. For instance, a user may initiate an HTTP request for a resource using a Web crawler, a Web browser, or other client deployed on a user system 102 that is owned by or otherwise accessible to the user. The user system 102 may request the resource using a single HTTP request or a plurality of HTTP requests. For instance, the plurality of HTTP requests may correspond to a plurality of respective portions of the resource.

An HTTP request may be any of any suitable type, including but not limited to an HTTP 200 request, an HTTP 206 request, etc. An HTTP 200 request requests that an entire resource be downloaded in a single download operation. An HTTP 206 request requests that a portion of the resource be downloaded in a respective download operation. For example, if an entire resource is not downloaded in response to an HTTP 200 request, one or more HTTP 206 requests subsequently may be provided to the Web server, requesting respective portions of the resource. In another example, a client may provide a plurality of HTTP 206 requests simultaneously to the Web server, requesting that a plurality of respective download operations corresponding to respective portions of the resource be downloaded simultaneously.

As depicted in FIG. 1, each of user systems 102A-102M is communicatively connected to Web server 104A for the purpose of requesting resources stored on (or otherwise accessible via Web server 104A). Persons skilled in the relevant art(s) will recognize that each of user systems 102A-102M is capable of connecting to any of Web servers 104A-104N to request resources.

Web servers 104A-104N are computers or other processing systems, each including one or more processors, that are capable of communicating with user systems 102A-102M. Web servers 104A-104N are configured to host respective Web sites, so that the Web sites are accessible to users of computer network 100. Web servers 104A-104N are further configured to provide resources to user systems 102A-102M in response to receiving HTTP requests from the user systems 102A-102M. For instance, the Web sites that are hosted by Web servers 104A-104N may include interface elements (e.g., “download” buttons) that the user may click to download respective resources.

Upon receiving an HTTP request for a resource, a Web server initiates a download session for downloading the requested resource to the user system 102 that provided the HTTP request. For example, the download session may include a single download operation for downloading the requested resource. In another example, the download session may include a plurality of download operations for downloading a plurality of respective portions of the requested resource. The download operation(s) may be performed solely by the Web server that received the HTTP request, solely by another Web server, or among a plurality of Web servers that may (or may not) include the Web server that received the request. For instance, the Web server that received the request may delegate one or more of the download operation(s) to other Web server(s).

Each of the Web servers 104A-104N generates a Web log entry for each download operation performed by that Web server. A Web log entry includes a query string representing the download request that corresponds to the download operation for which the Web log entry is generated. Examples of information included in the query string include but are not limited to a cookie, a client internet protocol (CIP) address, a user agent identifier, etc. A cookie assigns a unique identifier to a user system that provides a download request to a Web server. A CIP address is a unique string of numbers associated with the user system or a network proxy that provides the download request. A network proxy is a computer, other processing system, or software application that acts as an intermediary between a user system and a Web server(s). A user agent identifier indicates the environment on the user system that provides the download request. For instance, the user agent may indicate an operating system, a browser, or other application deployed on the user system (and/or a version thereof), a framework installed on the user system, etc. It will be recognized that a query string may include other information in addition to or in lieu of the example information described herein.

Each of the Web servers 104A-104N is configured to modify the Web log entries that it generates to include a session-specific identifier that is indicative of the download session with respect to which the Web log entries are generated. Web servers 104A-1 04N are further configured to modify the respective Web log entries to include byte range indicator(s) specifying byte range(s) of the requested resource that are requested (or downloaded) with respect to the respective download operation(s) of the download session. For instance, Web servers 104A-104N may be configured to extract information regarding the byte range(s) from respective download request(s) for inclusion in respective Web log entr(ies). Each of the Web servers 104A-104N may be configured to parse the Web log entries that it generates to extract the query string(s), session-specific identifier, and byte range indicator(s) for transmission to database server 106 for further processing.

Database server 106 is configured to determine whether download sessions are complete. To that end, database server aggregates information (e.g., query strings, session-specific identifiers, and byte range indicators) regarding download operations performed by Web servers 104A-104N. Database server is configured to match download sessions with download operations that are included in the download sessions based on associations between the download operations and session-specific identifiers that are indicative of the respective download sessions. For instance, a query string corresponding to a download operation may have been modified by a Web server to include a session-specific identifier that is indicative of a designated download session that includes the download operation. Database server 106 may review the modified query string to determine that the download operation is included in the designated download session.

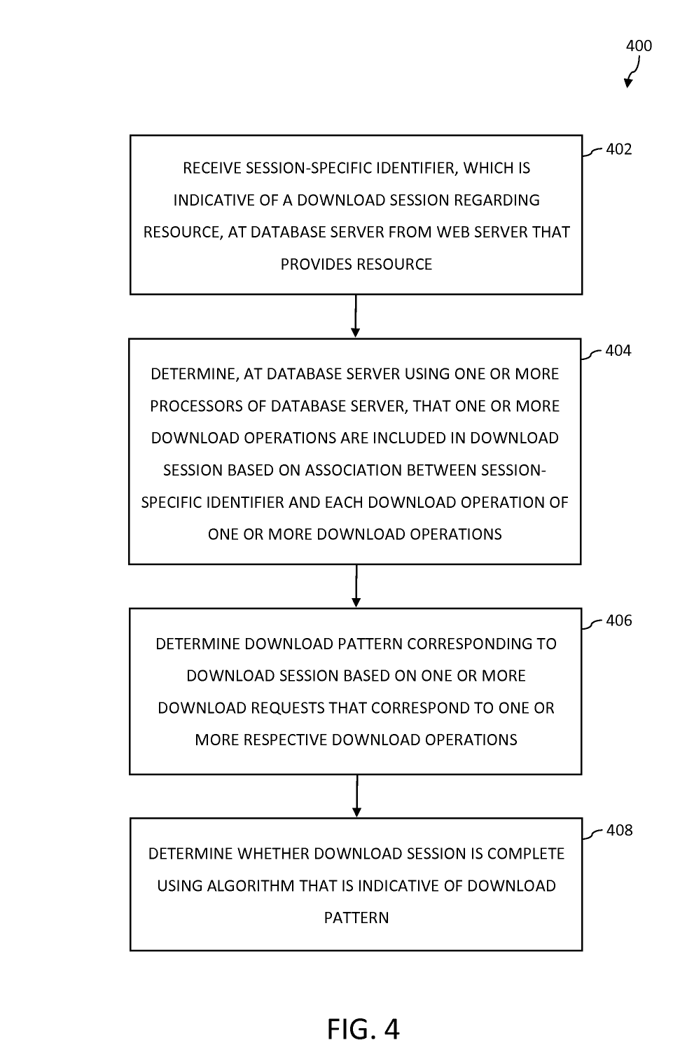

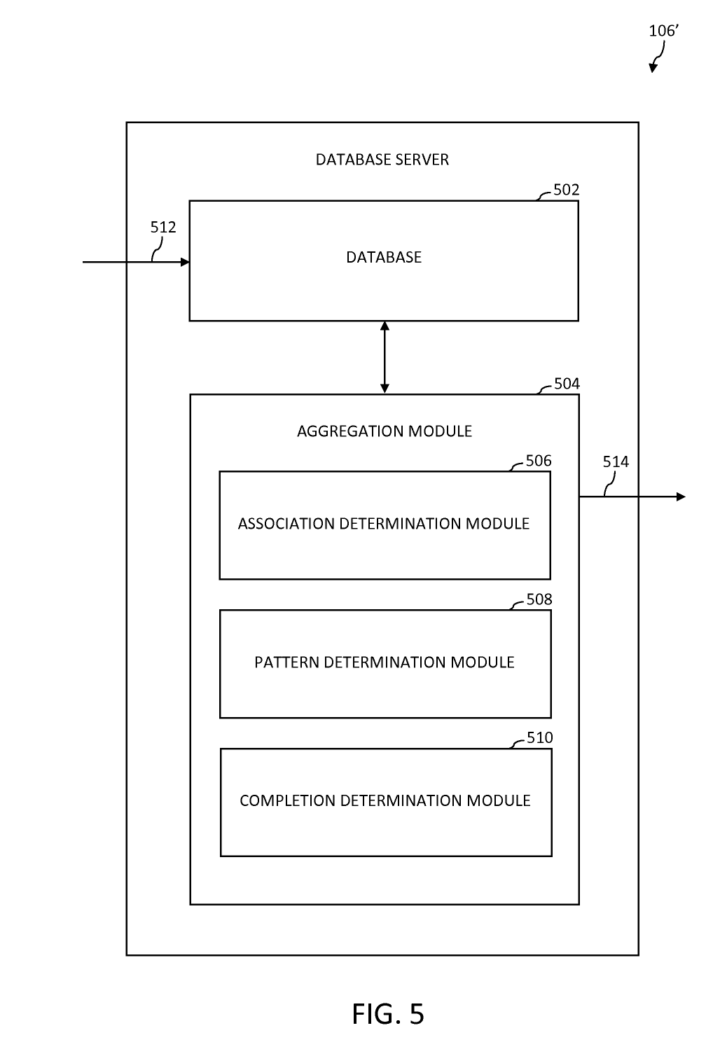

Database server 106 is further configured to determine which of a plurality of download patterns matches a download session based on request(s) that correspond to respective download operation(s) that are included in the download session. Some example download patterns are discussed below with reference to FIGS. 4 and 5.

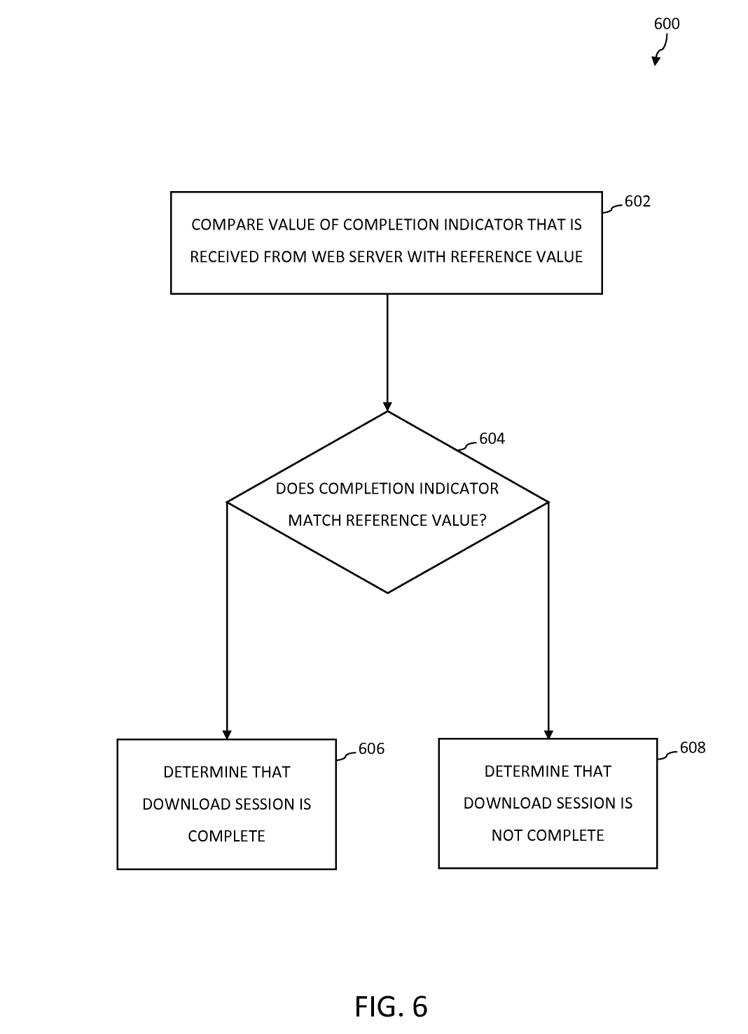

To determine whether a download session is complete, database server 106 performs an algorithm that is indicative of the download pattern that matches the download session. For instance, database server 106 may perform a first algorithm if the first download pattern matches the download session. Database server 106 may perform a second algorithm if the second download pattern matches the download session. Database server 106 may perform a third algorithm if the third download pattern matches the download session. Some example algorithms corresponding to respective download patterns are discussed below with reference to FIGS. 6-11.

Admin system 108 is a computer or other processing system that is capable of communicating with database server 106. Admin system 108 is configured to process information stored by database server 106. For instance, admin system 108 may use such information to generate a report indicating whether a download session is complete or which download session(s) of a plurality of download sessions are complete. The report may include statistics regarding the number of completed download sessions with respect to the number of attempted download sessions for each download pattern.

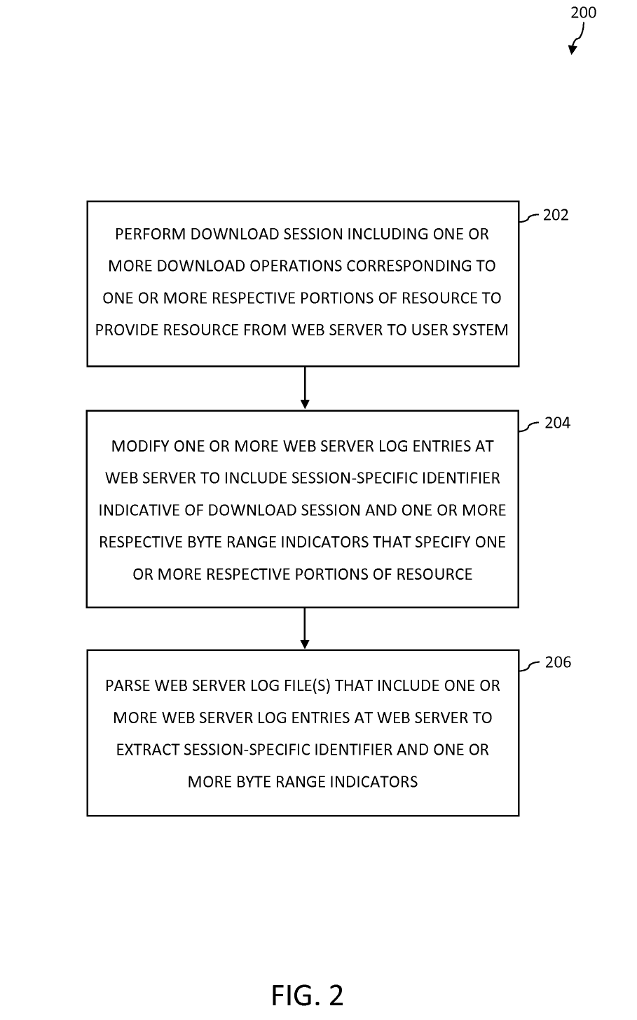

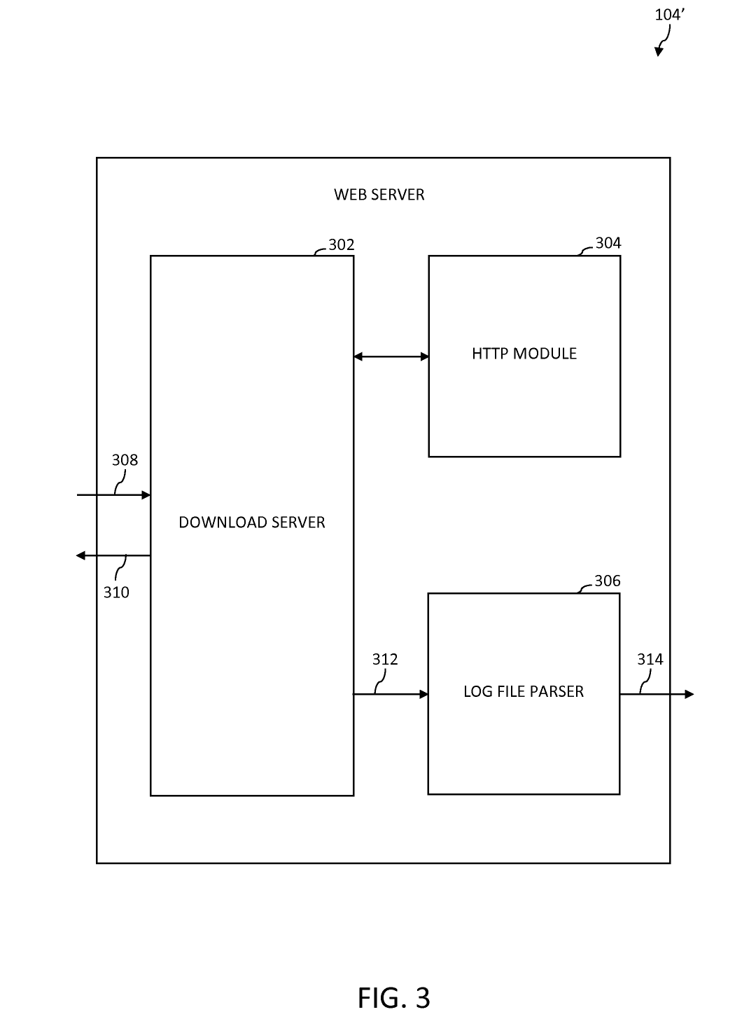

FIG. 2 depicts a flowchart 200 of a method for providing information to facilitate determining completion of a Web server download session in accordance with an embodiment. Flowchart 200 is described from the perspective of a Web server. Flowchart 200 may be performed by Web server 104 shown in FIG. 1, for example. For illustrative purposes, flowchart 200 is described with respect to a Web server 104′ shown in FIG. 3, which is an example of Web server 104, according to an embodiment. In this document, whenever a prime is used to modify a reference number, the modified reference number indicates an example (or alternate) implementation of the element that corresponds to the reference number.

As shown in FIG. 3, Web server 104′ includes a download server 302, an HTTP module 304, and a log file parser 306. Further structural and operational embodiments will be apparent to persons skilled in the relevant art(s) based on the discussion regarding flowchart 200. Flowchart 200 is described as follows.

As shown in FIG. 2, the method of flowchart 200 begins at step 202. In step 202, a download session including one or more download operations corresponding to one or more respective portions of a resource is performed to provide the resource from a Web server to a user system. In an example implementation, download server 302 of Web server 104′ performs the download session. In another example implementation, download operations of the download session are performed among a plurality of Web servers. For instance, the plurality of Web servers may perform a plurality of respective download operations that constitute the download session.

At step 204, one or more Web server log entries are modified at the Web server to include a session-specific identifier indicative of the download session. The one or more Web server log entries are further modified at the Web server to include one or more respective byte range indicators that specify one or more respective portions of the resource. In an example implementation, HTTP module 304 modifies the Web server log entries to include the session-specific identifier and the one or more respective byte range indicators.

At step 206, Web server log file(s) that include the one or more Web server log entries are parsed at the Web server to extract the session-specific identifier and the one or more byte range indicators. The session-specific identifier may be included in a hierarchical session identifier associated with the download session. For instance the hierarchical session identifier may include the session-specific identifier, a cookie, a client internet protocol (CIP) address, and/or a user agent identifier, all of which are described in detail above with reference to FIG. 1. In an example implementation, log file parser 306 parses the Web server log file(s).

FIG. 4 depicts a flowchart 400 of a method for determining completion of a Web server download session in accordance with an embodiment. Flowchart 400 is described from the perspective of a database server. The method of flowchart 400 may be performed by database server 106 shown in FIG. 1, for example. For illustrative purposes, flowchart 400 is described with respect to a database server 106′ shown in FIG. 5, which is an example of database server 106, according to an embodiment.

As shown in FIG. 5, database server 106′ includes a database 502 and an aggregation module 504. Aggregation module 504 includes an association determination module 506, a pattern determination module 508, and a completion determination module 510. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402. In step 402, a session-specific identifier, which is indicative of a download session regarding a resource, is received at a database server from a Web server that provides the resource. In an example implementation, database 502 receives the session-specific identifier. In accordance with this example implementation, database 502 may receive session-specific identifiers from a plurality of Web servers (e.g., Web servers 104A-104N). Database 502 may receive other information from the plurality of Web servers, as well. For instance, the other information may include byte range indicators that specify respective ranges of data, with each of the byte range indicators being indicative of a respective resource. Database 502 may store the session-specific identifiers and/or other information received from the plurality of Web servers in a plurality of respective clusters of database 502.

At step 404, a determination is made, at the database server using one or more processors of the database server, that one or more download operations are included in the download session based on an association between the session-specific identifier and each download operation of the one or more download operations. For instance, the session-specific identifier may be included in a hierarchical session identifier associated with the download session. The hierarchical session identifier may include any of a variety of indicators to facilitate determining that the one or more download operations are included in the download session. For example, the hierarchical session identifier may include the session-specific identifier, a cookie, a client internet protocol (CIP) address, and/or a user agent identifier, all of which are described in greater detail above with reference to FIG. 1. A cookie assigns a unique identifier to a user system that provides a download request to a Web server. A CIP address is a unique string of numbers associated with the user system or a network proxy that provides the download request. A user agent identifier indicates the environment on the user system that provides the download request.

The database server may initially use the session-specific identifier to determine that the one or more download operations are included in the download session. As an alternative, the database server may use the cookie to make the determination. As another alternative, the database server may use the CIP address, the user agent, or a combination thereof to make the determination. In an example implementation, association determination module determines that the one or more download operations are included in the download session.

At step 406, a download pattern corresponding to the download session is determined based on one or more download requests that correspond to the one or more respective download operations. For instance, a first download pattern may be indicative of a full content download session. A full content download session is a Web server download session in which an entire resource is downloaded in a single download operation. The download operation may be performed in response to an HTTP 200 request, for example.

A second download pattern may be indicative of a substantially sequential partial content download session. A substantially sequential partial content download session is a Web server download session that includes a plurality of download operations performed in response to a respective plurality of download requests, where one download request of the plurality of download requests specifies a byte range that includes the last byte of the requested resource. For example, the plurality of download requests may include an HTTP 200 request and at least one HTTP 206 request. It should be noted that a substantially sequential partial content download session may include download operations corresponding to overlapping portions of the requested resource.

A third download pattern may be indicative of a non-sequential partial content download session. A non-sequential partial content download session is a Web server download session that includes a plurality of download operations performed in response to a respective plurality of download requests, wherein more than one download request of the plurality of download requests specifies a byte range that includes the last byte of the requested resource. For example, the plurality of download requests may include an HTTP 200 request and at least one HTTP 206 request. In another example, each download request of the plurality of download requests may be an HTTP 206 request.

The example download patterns described above are provided for illustrative purposes and are not intended to be limiting. Persons skilled in the relevant art(s) will recognize that any suitable download patterns may be used. Moreover, three example download patterns are discussed for illustrative purposes, though any number of download patterns may be used. In an example implementation, pattern determination module 508 determines the download pattern corresponding to the download session in accordance with step 406.

In an example embodiment, the download pattern may be determined based on the one or more download requests and one or more byte range indicators that specify one or more respective portions of the resource that are associated with the respective one or more download requests. For instance, byte range indicators that specify overlapping portions of the resource may be indicative of the third example download pattern described above, which corresponds to a non-sequential partial content download session.

At step 408, a determination is made as to whether the download session is complete using an algorithm that is indicative of the download pattern. In an example implementation, completion determination module 510 determines whether the download session is complete.

For instance, if the download pattern is determined to be the first download pattern described above (i.e., indicative of a full content download session), a first algorithm may be performed to determine whether the download session is complete. If the download pattern is determined to be the second download pattern described above (i.e., indicative of a substantially sequential partial content download session), a second algorithm may be performed to determine whether the download session is complete. If the download pattern is determined to be the third download pattern described above (i.e., indicative of a non-sequential partial content download session), a third algorithm may be performed to determine whether the download session is complete. Example implementations of the first, second, and third algorithms described above are discussed below with reference to FIGS. 6-11.

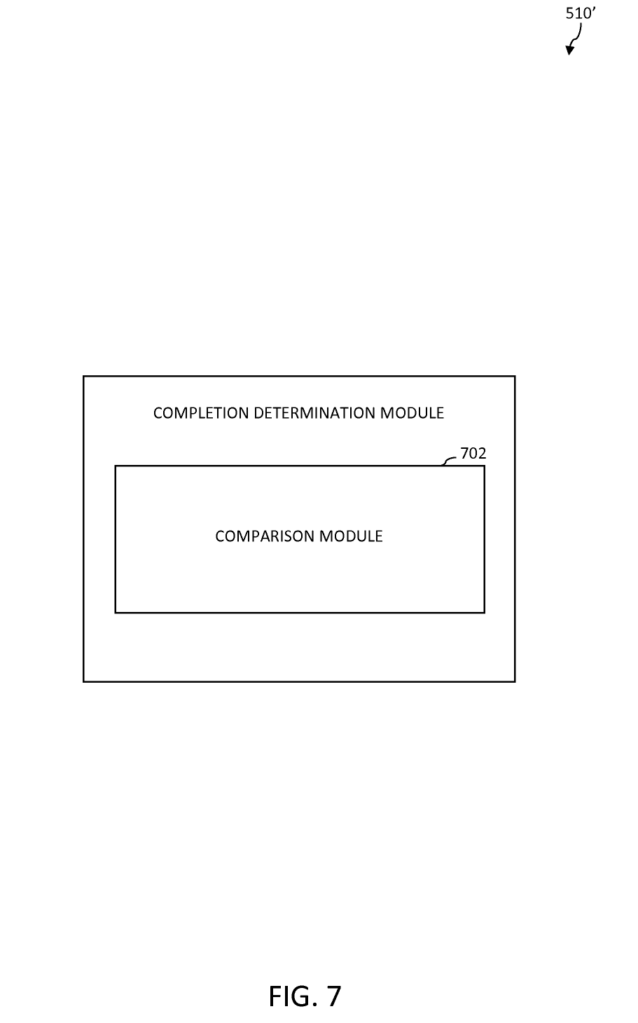

FIGS. 6, 8, and 10 depict flowcharts 600, 800, and 1000 of methods for determining completion of a Web server download session in accordance with embodiments. Flowcharts 600, 800, and 1000 are described from the perspective of a database server. The methods of flowcharts 600, 800, and 1000 may be performed by completion determination module 510 of database server 106′ shown in FIG. 5, for example. For illustrative purposes, flowcharts 600, 800, and 1000 are described with respect to respective completion determination modules 510′, 510″, and 510′″ shown in respective FIGS. 7, 9, and 11, which are examples of completion determination module 510, according to embodiments.

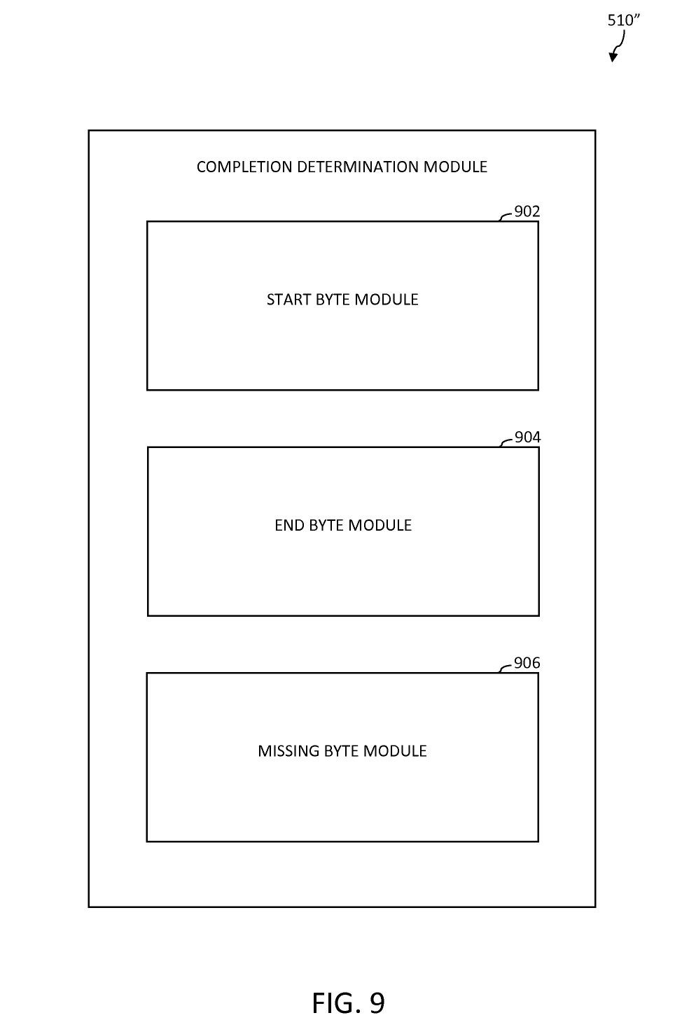

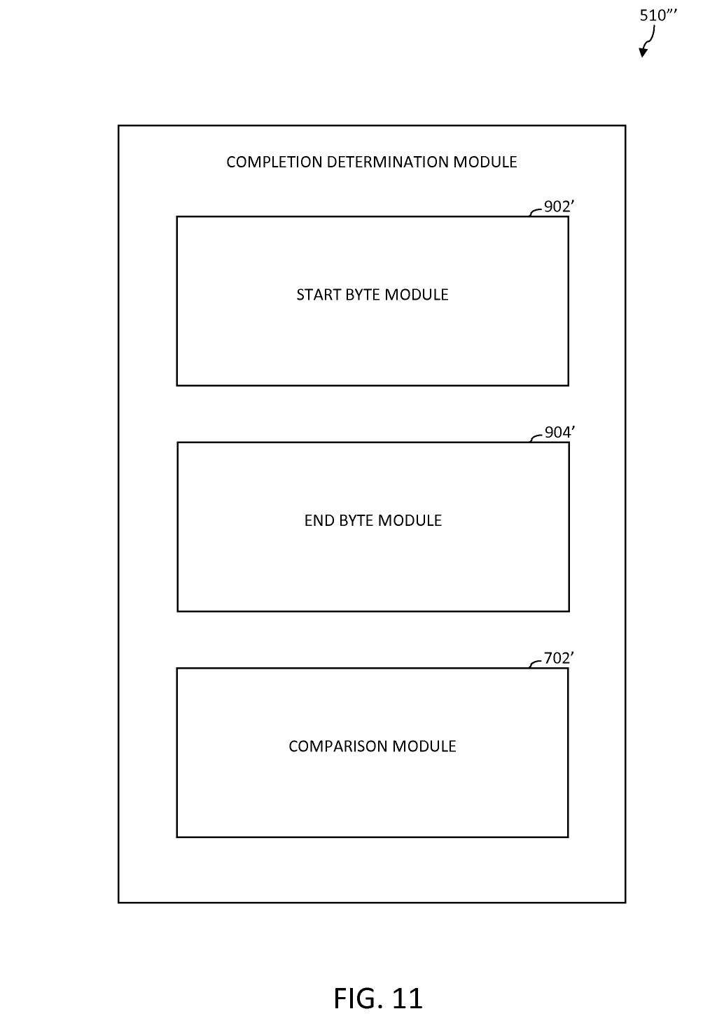

As shown in FIG. 7, completion determination module 510′ includes a comparison module 702. As shown in FIG. 9, completion determination module 510″ includes a start byte module 902, an end byte module 904, and a missing byte module 906. As shown in FIG. 9, completion determination module 510″ includes a start byte module 902, an end byte module 904, and a missing byte module 906. As shown in FIG. 11, completion determination module 510′″ includes a start byte module 902′, an end byte module 904′, and a comparison module 702′. Further structural and operational embodiments will be apparent to persons skilled in the relevant art(s) based on the discussion regarding flowcharts 600, 800, and 1000. Flowchart 600 is described as follows.

FIG. 6 is a flowchart 600 of a method that may be performed for determining completion of a full content download session, for example, corresponding to the first download pattern described above with reference to FIGS. 4 and 5. It will be recognized that the method of flowchart 600 may be performed for determining completion of any suitable download session. As shown in FIG. 6, the method of flowchart 600 begins at step 602. In step 602, a value of a completion indicator that is received from the Web server is compared with a reference value to determine whether the completion indicator matches the reference value. For example, the completion indicator may be Win32 application programming interface (API) indicator or any other suitable indicator.

At step 604, a determination is made as to whether the completion indicator matches the reference value. If the completion indicator matches the reference value, a determination is made that the download session is complete at step 606. However, if the completion indicator does not match the reference value, a determination is made that the download session is not complete at step 608. For example, assume that the reference value is zero, and the completion indicator is a Win32 indicator. In this example, a Win32 indicator having a value of zero is deemed to match the reference value of zero, resulting in a determination that the download session is complete. In an example implementation, steps 602, 604, and either step 606 or step 608 are performed by comparison module 702 of completion determination module 510′.

Example implementations in which the reference value is set to correspond to a non-completion of the download session are within the scope of the embodiments. In such example implementations, if the completion indicator matches the reference value, a determination is made that the download session is not complete at step 608. However, if the completion indicator does not match the reference value, a determination is made that the download session is complete at step 606.

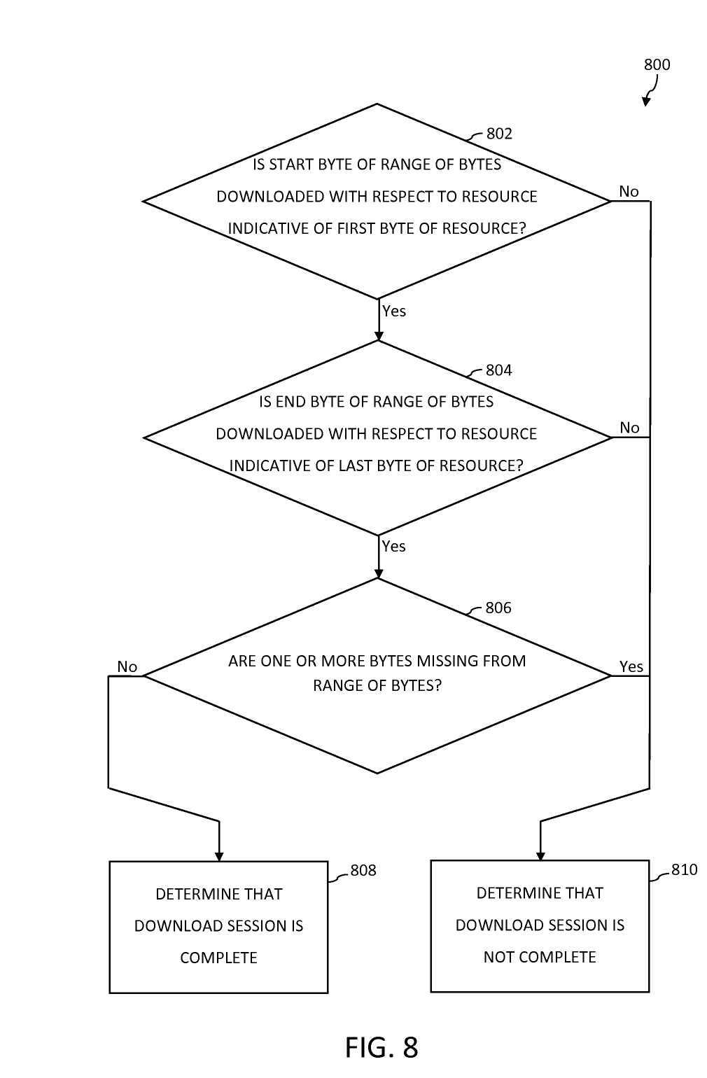

FIG. 8 is a flowchart 800 of a method that may be performed for determining completion of a substantially sequential partial content download session, for example, corresponding to the second download pattern described above with reference to FIGS. 4 and 5. It will be recognized that the method of flowchart 800 may be performed for determining completion of any suitable download session. As shown in FIG. 8, the method of flowchart 800 begins at step 802. In step 802, a determination is made as to whether a start byte of a range of bytes downloaded with respect to the resource is indicative of a first byte of the resource. For instance, the first byte of the resource may be referenced as byte [0000]. The start byte of the range of bytes may be referenced as byte [0000], as well, meaning that the start byte of the range of bytes is indicative of the first byte of the resource.

If the start byte of the range of bytes downloaded with respect to the resource is not indicative of the first byte of the resource, control flows to step 810. Otherwise, control flows to step 804. In an example implementation, start byte module 902 of completion determination module 510″ determines whether the start byte of the range of bytes downloaded with respect to the resource is indicative of the first byte of the resource.

At step 804, a determination is made as to whether an end byte of the range of bytes downloaded with respect to the resource is indicative of a last byte of the resource. For instance, the last byte of the resource may be references as byte[XXXX], wherein XXXX is equal to the number of bytes that constitute the reference, minus one. The end byte of the range of bytes downloaded with respect to the resource may be referenced as byte [XXXX], as well, meaning that the end byte of the range of bytes is indicative of the last byte of the resource.

If the end byte of the range of bytes downloaded with respect to the resource is not indicative of the last byte of the resource, control flows to step 810. Otherwise, control flows to step 806. In an example implementation, end byte module 904 determines whether the end byte of the range of bytes is indicative of the last byte of the resource.

At step 806, a determination is made as to whether one or more bytes are missing from the range of bytes. The determination may be based on the number of bytes in the range of bytes downloaded with respect to the resource being equal to or greater than the number of bytes that constitute the resource. The determination may be further based on completion of a last download operation of a plurality of download operations that are included in the download session. For instance, a determination that the download session is complete may require that the number of bytes in the range of bytes downloaded with respect to the resource be equal to or greater than the number of bytes that constitute the resource and completion of the last download operation.

If one or more bytes are missing from the range of bytes, a determination is made that the download session is complete at step 808. However, if no bytes are missing from the range of bytes, a determination is made that the download session is not complete at step 810. In an example implementation, steps 806 and either 808 or 810 are performed by missing byte module 906.

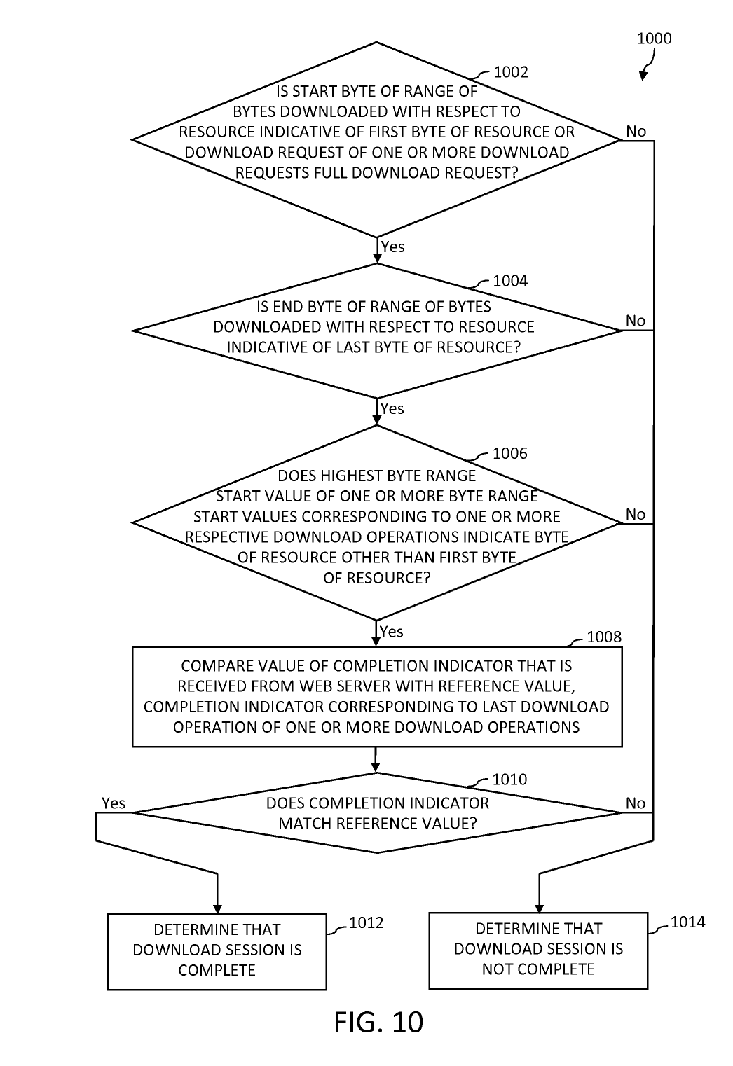

FIG. 10 is a flowchart 1000 of a method that may be performed for determining completion of a non-sequential partial content download session, for example, corresponding to the third download pattern described above with reference to FIGS. 4 and 5. It will be recognized that the method of flowchart 1000 may be performed for determining completion of any suitable download session. As shown in FIG. 10, the method of flowchart 1000 begins at step 1002. In step 1002, a determination is made as to whether a start byte of a range of bytes downloaded with respect to the resource is indicative of a first byte of the resource or a download request of the one or more download requests is a full download request.

The start byte of the range of bytes downloaded with respect to the resource being indicative of the first byte of the resource may represent a first condition. The download request of the one or more download requests being a full download request may represent a second condition. If neither the first condition nor the second condition is satisfied (i.e., neither is true), control flows to step 1014. However, if one or both of the first and second conditions are satisfied, control flows to step 1004. In an example implementation, start byte module 902′ of completion determination module 510′″ performs step 1002.

At step 1004, a determination is made as to whether an end byte of the range of bytes downloaded with respect to the resource is indicative of a last byte of the resource. The end byte of the range of bytes downloaded with respect to the resource is not indicative of the last byte of the resource, control flows to step 1014. Otherwise, control flows to step 1006. In an example implementation, end byte module 904′ determines whether the end byte of the range of bytes downloaded with respect to the resource is indicative of the last byte of the resource.

At step 1006, a determination is made as to whether a highest byte range start value of one or more byte range start values corresponding to the one or more respective download operations indicates a byte of the resource other than a first byte of the resource. For example, the download session may include a plurality of download operations, each having a respective byte range start value. In accordance with this example, having a highest range start value that indicates the first byte of the resource suggests that the download session includes a single download operation, which is inconsistent with a non-sequential partial content download session, for example. In an example implementation, start byte module 902′ determines whether the highest byte range start value of the one or more byte range start values indicates a byte of the resource other than the first byte of the resource.

At step 1008, a value of a completion indicator that is received from the Web server is compared with a reference value. The completion indicator corresponds to a last download operation of the one or more download operations. For example, the completion indicator may be Win32 application programming interface (API) indicator or any other suitable indicator.

At step 1010, a determination is made as to whether the completion indicator matches the reference value. If the completion indicator matches the reference value, a determination is made that the download session is complete at step 1012. However, if the completion indicator does not match the reference value, a determination is made that the download session is not complete at step 1014. For example, assume that the reference value is zero, and the completion indicator is a Win32 indicator. In this example, a Win32 indicator having a value of zero is deemed to match the reference value of zero, resulting in a determination that the download session is complete. In an example implementation, steps 1008, 1010, and either step 1012 or step 1014 are performed by comparison module 702′.

Example implementations in which the reference value is set to correspond to a non-completion of the download session are within the scope of the embodiments. In such example implementations, if the completion indicator matches the reference value, a determination is made that the download session is not complete at step 1014. However, if the completion indicator does not match the reference value, a determination is made that the download session is complete at step 1012.

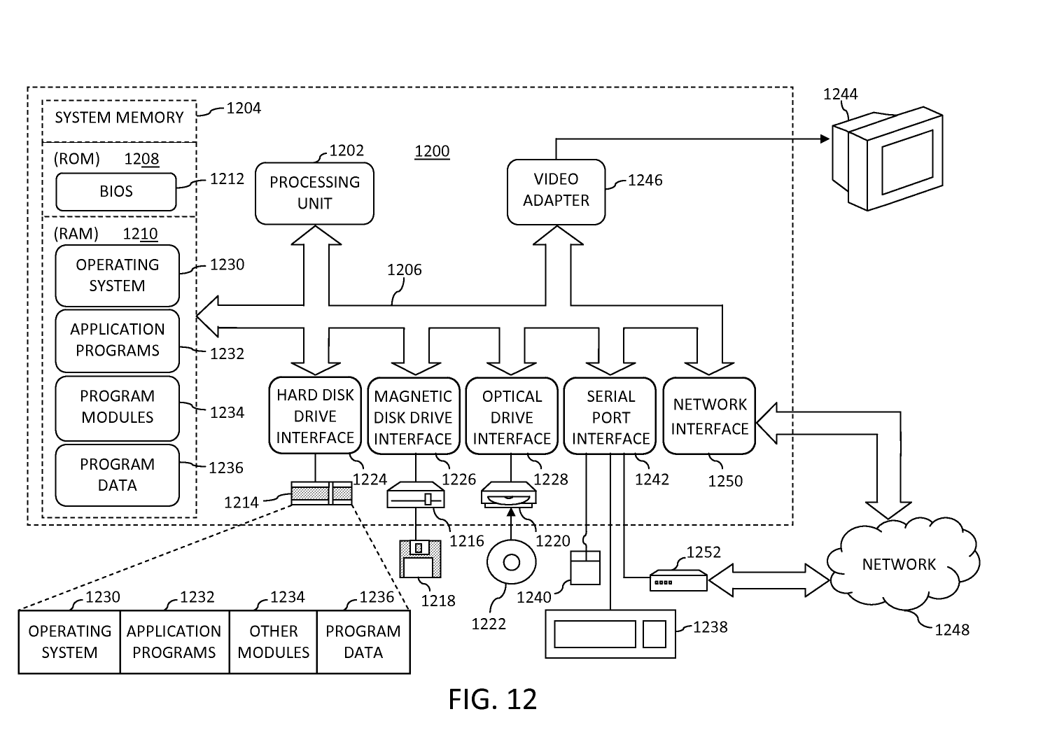

FIG. 12 depicts an example computer 1200 in which embodiments may be implemented. Any one or more of the user systems 102A-102M, Web servers 104A-104N, database server 106, or admin system 108 shown in FIG. 1 (or any one or more subcomponents thereof shown in FIGS. 3, 5, 7, 9, and 11) may be implemented using computer 1200, including one or more features of computer 1200 and/or alternative features. Computer 1200 may be a general-purpose computing device in the form of a conventional personal computer, a mobile computer, or a workstation, for example, or computer 1200 may be a special purpose computing device. The description of computer 1200 provided herein is provided for purposes of illustration, and is not intended to be limiting. Embodiments may be implemented in further types of computer systems, as would be known to persons skilled in the relevant art(s).

As shown in FIG. 12, computer 1200 includes a processing unit 1202, a system memory 1204, and a bus 1206 that couples various system components including system memory 1204 to processing unit 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic for implementing download server 302, HTTP module 304, log file parser 306, aggregation module 504, association determination module 506, pattern determination module 508, completion determination module 510, comparison module 702, start byte module 902, end byte module 904, missing byte module 906, start byte module 902′, end byte module 904′, comparison module 702′, flowchart 200 (including any step of flowchart 200), flowchart 400 (including any step of flowchart 400), flowchart 600 (including any step of flowchart 600), flowchart 800 (including any step of flowchart 800), and/or flowchart 1000 (including any step of flowchart 1000), as described herein.

A user may enter commands and information into the computer 1200 through input devices such as keyboard 1238 and pointing device 1240. Other input devices (not shown) may include a microphone, joystick, game pad, satellite dish, scanner, or the like. These and other input devices are often connected to the processing unit 1202 through a serial port interface 1242 that is coupled to bus 1206, but may be connected by other interfaces, such as a parallel port, game port, or a universal serial bus (USB).

A monitor 1244 or other type of display device is also connected to bus 1206 via an interface, such as a video adapter 1246. In addition to the monitor, computer 1200 may include other peripheral output devices (not shown) such as speakers and printers.

Computer 1200 is connected to a network 1248 (e.g., the Internet) through a network interface or adapter 1250, a modem 1252, or other means for establishing communications over the network. Modem 1252, which may be internal or external, is connected to bus 1206 via serial port interface 1242.

As used herein, the terms “computer program medium” and “computer-readable medium” are used to generally refer to media such as the hard disk associated with hard disk drive 1214, removable magnetic disk 1218, removable optical disk 1222, as well as other media such as flash memory cards, digital video disks, random access memories (RAMs), read only memories (ROM), and the like.

As noted above, computer programs and modules (including application programs 1232 and other program modules 1234) may be stored on the hard disk, magnetic disk, optical disk, ROM, or RAM. Such computer programs may also be received via network interface 1250 or serial port interface 1242. Such computer programs, when executed or loaded by an application, enable computer 1200 to implement features of embodiments discussed herein. Accordingly, such computer programs represent controllers of the computer 1200.

Embodiments are also directed to computer program products comprising software (e.g., computer-readable instructions) stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

Example embodiments described herein have a variety of benefits, as compared to conventional download tracking techniques that are available to system administrators. For instance, example embodiments may advantageously determine completion of a Web server download session at a database server with greater accuracy, as compared to the conventional download tracking techniques. At least some embodiments are capable of determining completion of a Web server download session with an accuracy that is indicative of client-based download tracking techniques.

Example embodiments are capable of determining completion of a download session that includes a plurality of download operations performed among a plurality of Web servers. For instance, the plurality of download operations may be performed by a plurality of respective download servers. Example embodiments are capable of determining completion of a download session that is paused and resumed one or more times.

In accordance with some example embodiments, a Web server is capable of modifying Web server log entries corresponding to respective download requests to include a session-specific identifier and/or respective byte range indicators to facilitate determining completion of a Web server download session. The session-specific identifier is indicative of the Web server download session, which is used to download the resource. The byte range indicators specify respective portions of the resource, which are downloaded in respective download operations of the Web server download session.

According to some example embodiments, a database server uses the session-specific identifier and/or the byte range indicators received from the Web server to determine whether the download session is complete. For instance, the database server uses the session-specific identifier to determine which download operation(s) are included in the Web server download session. The database server determines a download pattern corresponding to the Web server download session based on download request(s) that correspond to the download operation(s). The database server determines whether the download session is complete using an algorithm that is indicative of the download pattern. For example, a different algorithm may be used for each download pattern.

### III. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
receiving a session-specific identifier that is indicative of a download session regarding a resource, the session-specific identifier being received at a database server from a Web server that provides the resource;
determining at the database server using one or more processors of the database server that one or more download operations are included in the download session based on an association between the session-specific identifier and each download operation of the one or more download operations;
determining a download pattern corresponding to the download session based on one or more download requests that correspond to the one or more respective download operations; and
determining whether the download session is complete using an algorithm that is indicative of the download pattern.

2. The method of claim 1, wherein the determining the download pattern comprises:
determining the download pattern based on the one or more download requests and one or more byte range indicators that specify one or more respective portions of the resource that are associated with the respective one or more download requests.

3. The method of claim 1, wherein the download pattern indicates that the download session is a full content download session.

4. The method of claim 3, wherein the determining whether the download session is complete using the algorithm comprises:
comparing a value of a completion indicator that is received from the Web server with a reference value to determine whether the completion indicator matches the reference value.

5. The method of claim 1, wherein the download pattern indicates that the download session is a substantially sequential partial content download session.

6. The method of claim 5, wherein the determining whether the download session is complete using the algorithm comprises:
determining whether a start byte of a range of bytes downloaded with respect to the resource is indicative of a first byte of the resource;
determining whether an end byte of the range of bytes downloaded with respect to the resource is indicative of a last byte of the resource; and
determining whether one or more bytes are missing from the range of bytes.

7. The method of claim 6, wherein the determining whether the one or more bytes are missing from the range of bytes comprises:
comparing a number of bytes in the range of bytes to a number of bytes that constitute the resource to determine whether the number of bytes in the range of bytes is equal to or greater than the number of bytes that constitute the resource.

8. The method of claim 1, wherein the download pattern indicates that the download session is a non-sequential partial content download session.

9. The method of claim 8, wherein the determining whether the download session is complete using the algorithm comprises:
determining whether a start byte of a range of bytes downloaded with respect to the resource is indicative of a first byte of the resource or a download request of the one or more download requests is a full download request;
determining whether an end byte of the range of bytes downloaded with respect to the resource is indicative of a last byte of the resource;
determining whether a highest byte range start value of one or more byte range start values corresponding to the one or more respective download operations indicates a byte of the resource other than a first byte of the resource; and
comparing a value of a completion indicator that is received from the Web server with a reference value to determine whether the completion indicator matches the reference value, the completion indicator corresponding to a last download operation of the one or more download operations.

10. A database server comprising:
a database coupled to a Web server, which provides a resource, for receiving a session-specific identifier from the Web server, the session-specific identifier indicative of a download session regarding the resource;
an association determination module configured to determine that one or more download operations are included in the download session based on an association between the session-specific identifier and each download operation of the one or more download operations;
a pattern determination module configured to determine a download pattern corresponding to the download session based on one or more download requests that correspond to the one or more respective download operations; and
a completion determination module configured to determine whether the download session is complete using an algorithm that is indicative of the download pattern.

11. The database server of claim 10, wherein the pattern determination module is configured to determine the download pattern based on the one or more download requests and one or more byte range indicators that specify one or more respective portions of the resource that are associated with the respective one or more download requests.

12. The database server of claim 10, wherein the pattern determination module is configured to determine that the download session is a full content download session based on the one or more download requests including a single download request; and
wherein the single download request is an HTTP 200 request.

13. The database server of claim 12, wherein the completion determination module comprises:
a comparison module configured to compare a value of a completion indicator that is received from the Web server with a reference value to determine whether the completion indicator matches the reference value, based on the download session being a full content download session.

14. The download server of claim 10, wherein the pattern determination module is configured to determine that the download session is a substantially sequential partial content download session based on the one or more download requests including an HTTP 200 request and at least one HTTP 206 request and further based on the one or more download requests including no more than one request that references a last byte of the resource.

15. The database server of claim 14, wherein the completion determination module comprises:
a start byte module configured to determine whether a start byte of a range of bytes downloaded with respect to the resource is indicative of a first byte of the resource;
an end byte module configured to determine whether an end byte of the range of bytes downloaded with respect to the resource is indicative of the last byte of the resource; and
a missing byte module configured to determine whether one or more bytes are missing from the range of bytes, based on the download session being a substantially sequential partial content download session.

16. The database server of claim 15, wherein the missing byte module is configured to compare a number of bytes in the range of bytes to a number of bytes that constitute the resource to determine whether the number of bytes in the range of bytes is equal to or greater than the number of bytes that constitute the resource.

17. The database server of claim 10, wherein the pattern determination module is configured to determine that the download session is a non-sequential partial content download session based on the one or more download requests including a plurality of download requests that includes at least one HTTP 206 request and further based on the one or more requests including a plurality of requests that reference a last byte of the resource.

18. The database server of claim 17, wherein the completion determination module comprises:
a start byte module configured to determine whether a start byte of a range of bytes downloaded with respect to the resource is indicative of a first byte of the resource or a download request of the one or more download requests is a full download request;
an end byte module configured to determine whether an end byte of the range of bytes downloaded with respect to the resource is indicative of a last byte of the resource, wherein the end byte module is further configured to determine whether a highest byte range start value of one or more byte range start values corresponding to the one or more respective download operations indicates a byte of the resource other than a first byte of the resource, based on the download session being a non-sequential partial content download session; and
a comparison module configured to compare a value of a completion indicator that is received from the Web server with a reference value to determine whether the completion indicator matches the reference value, the completion indicator corresponding to a last download operation of the one or more download operations.

19. A computer program product comprising a computer-readable medium having computer program logic recorded thereon for enabling a processor-based system to determine completion of a download session regarding a resource that is provided by a Web server, the computer program product comprising:
a first program logic module for enabling the processor-based system to determine that one or more download operations are included in the download session based on an association between a session-specific identifier received from the Web server and each download operation of the one or more download operations, the session-specific identifier indicative of the download session;
a second program logic module for enabling the processor-based system to determine a download pattern corresponding to the download session based on one or more download requests that correspond to the one or more respective download operations and one or more byte range indicators that specify one or more respective portions of the resource that are associated with the respective one or more download requests; and
a third program logic module for enabling the processor-based system to determine whether the download session is complete using an algorithm that is indicative of the download pattern.

20. The computer program product of claim 19, wherein the second program logic module includes instructions for enabling the processor-based system to determine that the download pattern indicates that the download session is a full content download session, a substantially sequential partial content download session, or a non-sequential partial content download session.
